(19) United States
(12) Patent Application Publication
(10) Pub. No.: US 2016/0359179 A1
(43) Pub. Date: Dec. 8, 2016

(54) OPTIMIZATION OF CONFIGURATION OF PARALLEL SYSTEMS FOR UNIFORM FLOW DISTRIBUTION

(71) Applicant: The University of North Carolina at Chapel Hill, Chapel Hill, NC (US)

(72) Inventors: Joshua Jackson, Carrboro, NC (US); Mateusz L. Hupert, Chapel Hill, NC (US); Steven Soper, Baton Rouge, LA (US)

(21) Appl. No.: 15/109,167

(22) PCT Filed: Feb. 24, 2015
(86) PCT No.: PCT/US2015/017210

§ 371 Date: Jun. 30, 2016

Related U.S. Application Data
(60) Provisional application No. 61/944,762, filed on Feb. 26, 2014.

(51) Int. Cl. H01M 8/04089; F28F 13/06; F15D 1/00

(52) U.S. Cl. CPC H01M 8/04089; F15D 1/00; F28F 13/06; H01M 2008/1293

(57) ABSTRACT

A fluid array, comprises: (a) a fluid input header, (b) a fluid output header, and (c) a plurality of (preferably at least 26) parallel fluid channels, each of said fluid channels connected to both said fluid input header and said fluid output header in a Z-array configuration. Methods of using the same and fuel cells comprising such arrays are also described, along with methods of optimizing flow therein.

### RELATED APPLICATIONS

This application claims the benefit of U.S. Provisional Patent Application Ser. No. 61/944,762, filed Feb. 26, 2014, the disclosure of which is incorporated by reference herein in its entirety.

### FIELD OF THE INVENTION

The present invention concerns parallel fluidic and microfluidic arrays for use in fuel cells, diagnostic devices, cooling devices and the like.

### BACKGROUND OF THE INVENTION

Proper design of gas distributors for planar fuel cells is critical to realize optimal operation and maximum power output of a fuel cell stack. To date, many flow designs have been proposed, evaluated, and are being used for reagent delivery in commercial fuel cells [1-4]. Among different configurations, two extremes can be defined: (i) A single serpentine channel covering the entire electrochemically active area of the fuel cell; and (ii) an array of parallel channels, herein focusing on designs with inlet and outlet channels arranged in the so-called Z-type configuration [1, 5-7]. The serpentine channel provides the most uniform flow of reagents, but at the same time, suffers from the highest overall pressure drop. This is very undesirable for many high power systems with large electrode areas as the pump's power parasitically feeds from the fuel cell's power output [5]. On the other hand, parallel channel configurations offer the lowest pressure drop, as much as an order of magnitude lower than a serpentine channel covering the same area [8], but may suffer from severe flow maldistribution, where the middle channels are starved of reagent flow. This phenomenon can adversely affect a significant portion of the electroactive surface area and severely hampers power production of parallel-configured fuel cells [2-5, 7-20].

While several methods have been developed to numerically predict the flow distribution of reagents in parallel configurations [21], there are relatively few studies directed at reducing flow maldistribution by altering the Z-configuration's geometry [3, 18, 22-24]. As flow non-uniformity scales with the number of channels placed in parallel, various designs utilizing serially connected subsets of Z-geometries with fewer parallel channels, termed discontinuous geometries, have been proposed. However, applying a discontinuous parallel configuration typically increases parasitic pressure relative to a purely parallel design [3], and most critically, the fundamental non-uniform profiles remain even if they are reduced in magnitude. This last point was addressed by Zhang, et al., who successfully corrected the non-uniform flow profiles in a Z-type configuration by adjusting the parallel channels' widths to increase flow through the middle channels [18]. However, this optimization method was presented in an ad hoc fashion as the authors did not provide a universal solution that can be applied to any geometry, an important point considering parameters vary from one study to the next. Moreover, Kumar, et al. [25] has shown that optimal geometric parameters exist for the electroactive channels [5]. Altering the widths of the parallel channels may evenly distribute reagent flow to the middle channels but at the expense of decreased reaction efficiency. In contrast, header widths have been adjusted to curb flow non-uniformity in Z-type [23] and pin-type [24] configurations, but to date, no universal equation has been presented to predict how header shape should be adjusted to maximize flow uniformity in any Z-type design without the use of an optimization algorithm.

### SUMMARY OF THE INVENTION

Described herein is a fluid array, comprising: (a) a fluid input header, (b) a fluid output header, and (c) a plurality (N) of 26, 30, 40, 50 or 100, to 3,000, 4,000, or 5,000 or more, parallel fluid channels, each of said fluid channels connected to both said fluid input header and said fluid output header in a Z-array configuration, wherein the header segments are dimensioned as described herein, or the architecture or configuration of the array meets the criteria described herein, for enhancing fluid flow therein. Such arrays may be used in a variety of applications, including cooling (e.g., in electronic applications), in fuel cells for circulating air and/or fuel, and in diagnostic arrays.

Note that the dimensions of header segments given herein are average dimensions for each segment. It will be appreciated that the segments are generally “smoothed” such as by linear or curved functions, to avoid step changes or irregular changes in channel heights and widths between segments.

The present invention is explained in greater detail in the drawings herein and the specification set forth below.

### BRIEF DESCRIPTION OF THE DRAWINGS

FIG. 1. (A) Schematic diagram and (B) discrete representation of a Z-configuration geometry. Arrows represent the direction of flow.

FIG. 2. Labelled drawing of geometry I. Large, white arrows indicate direction of flow. Refer to Tables 1 and 3 for all parameters of geometries I-III and IV-V, respectively.

FIG. 3. Air flow distributions in (A) initial and (B) optimized geometries I-III calculated via (green) discrete and (red) CFD methods. Dashed lines represent perfectly distributed profiles.

FIG. 4. CFD models of air flow in (A) initial and (B) optimized geometries I-III.

FIG. 5. Discrete F₁ parameters for optimizations of geometry III using various percentages of the optimal header widths. The line connecting data points is for illustration only.

FIG. 6. CFD air flow profiles through geometry III in a (A) discontinuous configuration and an (B) optimized discontinuous configuration. The scale bar is shown in FIG. 3.

FIG. 7. Inlet header velocity profiles showing recirculation and minor losses in geometries I, IV, and V. Arrows indicate direction of flow.

FIG. 8. The (A) initial and (B) optimized CFD flow distributions of (red) air and (blue) hydrogen and (green) discrete solution through geometries IV and V. Dashed lines represent perfectly distributed profiles.

### Detailed Description of Illustrative Embodiments

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

Like numbers refer to like elements throughout. In the figures, the thickness of certain lines, layers, components, elements or features may be exaggerated for clarity. Where used, broken lines illustrate optional features or operations unless specified otherwise.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof.

As used herein, the term “and/or” includes any and all possible combinations or one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature can have portions that overlap or underlie the adjacent feature.

Spatially relative terms, such as “under,” “below,” “lower,” “over,” “upper” and the like, may be used herein for ease of description to describe an element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus the exemplary term “under” can encompass both an orientation of over and under. The device may otherwise be oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only, unless specifically indicated otherwise.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section. Thus, a first element, component, region, layer or section discussed herein could be termed a second element, component, region, layer or section without departing from the teachings of the present invention. The sequence of operations (or steps) is not limited to the order presented in the claims or figures unless specifically indicated otherwise.

As noted above, the present invention provides a fluid array, comprising: (a) a fluid input header, (b) a fluid output header, and (c) a plurality (N) of 26, 30, 40, 50 or 100, to 3,000, 4,000, or 5,000 or more, parallel fluid channels, each of said fluid channels connected to both said fluid input header and said fluid output header in a Z-array configuration.

Each of said fluid input and fluid output headers comprising a terminal channel followed by a plurality (N-1) of segments, with each of said segments forming a junction with a corresponding one of said parallel channels, and with each of said segments having a length (L), a width (W), a height (H), and a contact area (A_{T}) at said junction;

with the resistance-to-area ratio (R/A) of each of said (i) input header segments given by Equation A:

$$\frac{{R}_{i}}{{A}_{i}} = {∝}_{i} \cdot \frac{i}{( N + 1 - i )} \cdot \frac{{R}_{N + 1 - i}}{{A}_{N + 1 - i}} \qquad ( A )$$

and with the resistance-to-area ratio (R/A) of each of said (j) output header segments given by Equation B:

$$\frac{{R}_{j}}{{A}_{j}} = {∝}_{j} \cdot \frac{( N + 1 - j )}{j} \cdot \frac{{R}_{N + 1 - j}}{{A}_{N + 1 - j}} \qquad ( B )$$

and the R/A of each of said segments given by Equation C:

$$\frac{R}{A} = \frac{μ \cdot L \cdot Re \cdot f \cdot {( W + H )}^{2}}{2 \cdot {W}^{3} \cdot {H}^{3}} + \frac{μ \cdot {A}_{T} \cdot Re \cdot f \cdot ( W + H )}{4 \cdot {W}^{3} \cdot {H}^{3}} \qquad ( C )$$

where μ is the fluid's viscosity, Re is the Reynolds number, and f is the friction factor;

and with W and/or H in 70, 80, 90, or 95 percent of said segments configured to satisfy Equation A and Equation B with ∝ within 0.2, 0.5, or 0.7 to 1.3, 1.5, or 2 and give a flow non-uniformity index F₁ of less than 0.3, 0.2, or 0.1 according to Equation D:

$${F}_{1} = \frac{max ( {v}_{1} \text{:} {v}_{N} ) - min ( {v}_{1} \text{:} {v}_{N} )}{max ( {v}_{1} \text{:} {v}_{N} )} \qquad ( D )$$

and/or a relative standard deviation of v₁:v_{N} less than 5, 10, 15, 20, or 25 percent, where v₁ is the fluid's average velocity in the i^{th} parallel channel.

The parallel channels may be arranged in any suitable geometry, including linear, curved, inverse curved, or a combination thereof (e.g., sinusoidal).

The array may be formed in any suitable material, including inorganic substrates (e.g., silicon, glass, etc.) and polymer substrate (e.g., fluorocarbons).

The array may be configured to carry any of a variety of fluids, including gases and liquids, and (for liquids) both Newtonian and non-Newtonian fluids. Examples include, but are not limited to, air, O₂, CO₂, H₂, alcohols, hydrocarbons and hydrocarbon mixtures, dielectric fluids, refrigerants and coolants (e.g., halocarbons such as fluorocarbons), oils, liquid nitrogen, water or aqueous solutions, biological fluids (e.g., blood, blood serum, blood plasma, buffy coat, urine, saliva, cerebral spinal fluid, optionally diluted and/or partially purified), etc.

Diagnostic arrays. In some embodiments, at least some, a major portion, or all of said parallel channels have a binding ligand immobilized therein (e.g., a protein, peptide, nucleic acid, carbohydrate, etc., binding ligand, such as an antibody). The binding ligand may serve as a second member of a binding pair. Such arrays may be used to detect a first member of a binding pair (e.g., cells, proteins, peptides, hormones, drugs, etc.) in a liquid sample (e.g., a biological fluid such as those described above) by (a) passing the fluid through a microarray having a second member of a binding pair immobilized therein, and (b) detecting the binding of said first member to said second member in said array (with detection being carried out by any of a variety of known techniques, such as sandwich assay with a fluorescent labeled antibody).

Heat exchangers. In some embodiments, the array comprises a fluid channel array for a heat exchanger (e.g., for cooling circuitry in electronic and microelectronic applications). Such arrays may be used to transfer heat to or from a coolant or refrigerant fluid by circulating the fluid through a fluid channel array in such a a heat exchanger in a heat-transfer effective amount (ultimately circulating the fluid to a heat sink in accordance with known techniques).

MEA layers for fuel cells. In some embodiments, the array comprises a fuel channel array or an air channel array for a fuel cell electrode-electrolyte assembly (MEA) layer (examples of which are described further below). In use, such embodiments provide a method of circulating fuel or air through a fuel or air channel array in a fuel cell in an energy-generating effective amount.

Fuel cells. Fuel cells such as is a planar solid-oxide fuel cell (SOFC), generally comprise: (a) a primary fuel inlet header; (b) a primary fuel outlet header; (c) a primary oxygen inlet header; and (d) a primary oxygen outlet header; and (e) a plurality of at least 10, 20, 30, 40 or 50, up to 100, 200, 1,000 or 2,000 or more membrane electrode assembly (MEA) layers, each of said layers comprising: a semipermeable membrane, a plurality of fuel channels on one side of said semipermeable membrane, a plurality of oxygen channels on the opposite side of said semipermeable membrane, a secondary fuel inlet header and a secondary fuel outlet header, each in fluid communication with said plurality of fuel channels; and a secondary oxygen inlet header and a secondary oxygen outlet header, each in fluid communication with said plurality of oxygen channels.

In general, fuel channels and oxygen channels are arranged in counter-flow, cross-flow, or co-flow configurations. In some embodiments, the semipermeable membrane comprises an anode layer facing said fuel channels, a cathode layer facing said oxygen channels, and an electrolyte layer separating said anode layer and said cathode layer.

“Oxygen channel” as used herein with respect to fuel cell arrays may carry pure oxygen gas, or any suitable fluid or gas in pure or mixed form containing sufficient oxygen for the fuel cell to generate energy (e.g., air).

As noted above, the individual oxygen or fuel arrays in each MEA layers may be an array as described above. In addition, however, (/) the primary fuel input and primary fuel output headers, and/or (g) the primary oxygen input and primary oxygen output headers, may be dimensioned in like manner as described above, to further enhance fluid flow therein.

In use, the fuel cells provide a method of circulating fuel and/or oxygen through the fuel and/or oxygen channel arrays therein in an energy-generating effective amount, wherein flow of the fuel and/or oxygen is enhanced by imparting the configurations described herein, thereby increasing the efficiency and/or capacity of the fuel cell.

The present invention is explained in greater detail in the following non-limiting Examples.

### EXPERIMENTAL

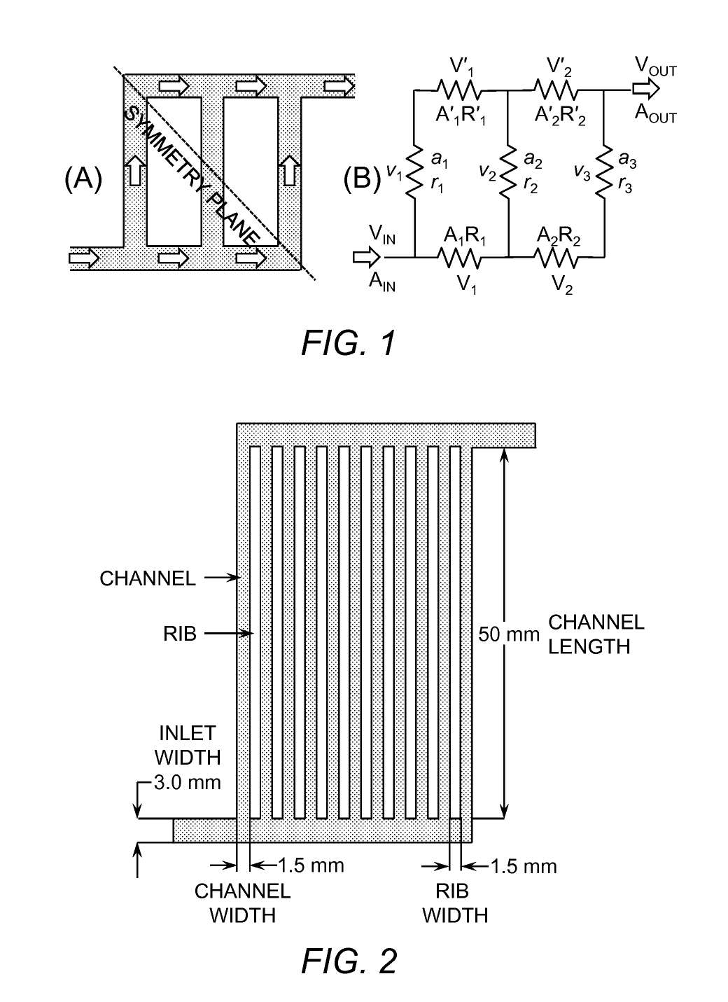

Herein, we present a simple and universal geometry optimization method to ensure uniform flow distribution in a Z-type fuel cell. We first generalize a discrete model (also termed a network analysis model) for Z-type configurations [18], where the geometry was subdivided into a network of individually defined fluidic resistors (see FIG. 1). The simplicity of such a model is desirable because pressure and mass balance equations may be defined and solved using only linear algebraic transformations of matrices, albeit these solutions are generally less descriptive than analytic methods or CFD simulations [18, 26]. We exploit this simplicity to optimize the Z-configuration geometry by assuming the case where flow is perfectly distributed throughout the fuel cell and the geometric parameters of the parallel channels are constant. This permitted us to reduce the governing pressure and mass balance equations into straight forward geometric ratios between the inlet headers' resistances and areas that can be satisfied by increasing header widths using a simple algorithm, thereby offering superior scalability to previously demonstrated optimization algorithms [23, 24]. We demonstrate this optimization process for several geometries and affirm the validity of these results by CFD simulation. This method comprised a simple yet effective approach for elucidating novel Z-type configurations of fuel cells, as well as fuel cell stacks, with markedly uniform flow distributions.

As an added benefit, the increased header widths reduce Reynolds numbers throughout the headers, thereby reducing flow recirculation in the branching tee junctions. In turn, this minimized asymmetric non-uniformity in reagent flow, parasitic minor loss pressure drops, and reagent imbalance between the cathode and anode, all of which have been detailed as concerns [3, 22, 26, 27]. Furthermore, we provide avenues by which an optimized fuel cell's footprint can be reduced while retaining flow uniformity.

### Nomenclature

A cross-sectional area of channel (m²)
aᵢ cross-sectional area of i^{th}parallel channel (m²)
aₚ cross-sectional area of parallel channels (m²)
Aᵢ cross-sectional area of i^{th} inlet header (m²)
Aᵢ′ cross-sectional area of i^{th} outlet header (m²)
Aᵢₙ cross-sectional area of plate inlet (m²)
A_{T}contact area of tee junction (m²)
D hydraulic diameter (m)
f friction factor
F₁ non-uniformity index
F₂ asymmetry index
F_{μ} volumetric drag force (N m⁻³)
H channel height (m)
L channel length (m)
N number of channels
P channel perimeter (m)
ΔP pressure drop (Pa)
ΔΔP change in pressure drop (Pa)
R resistance (kg m⁻² s⁻¹)
rᵢ resistance of i^{th} parallel channel (kg m⁻² s⁻¹)
Rᵢ resistance of i^{th} inlet header (kg m⁻² s⁻¹)
Rᵢ′ resistance of i^{th} outlet header (kg m⁻² s⁻¹)
R_{T} resistance of tee junction (kg m⁻² s⁻¹)
Re Reynolds number
u velocity field (m s⁻¹)
vᵢ velocity of i^{th} parallel channel (m s⁻¹)
vₚ velocity of parallel channels (m s⁻¹)
Vᵢ velocity of i^{th} inlet header (m s⁻¹)
Vᵢ′ velocity of i^{th} outlet header (m s⁻¹)
Vᵢₙ velocity of plate inlet (m s⁻¹)
W width (m)
Wᵢ width of i^{th} inlet header (m)

### Greek Letters

α aspect ratio
μ viscosity (kg m-¹ s⁻¹)

### 2. Computational Methods

### 2.1 Assumptions

Both discrete and CFD models make the same assumptions: (1) The fluid's density (ρ) and viscosity (μ) are constant; (2) temperature is held constant at 293.15 K; (3) the fluid flow is steady-state and laminar; and (4) mass transfer with the electrolyte layer is neglected [18, 20].

### 2.2 Discrete Model for Z-Configuration Geometries

We adopted a discrete model [18] in which a Z-type configuration fuel cell was segmented into a system of individual, interconnected fluidic resistors as seen in FIG. 1. A channel segment's geometry dictates resistance (R) to fluid flow by;

$${R}^{′} = \frac{1}{2} \frac{( Re f ) μ \cdot P \cdot L}{D \cdot A} \qquad ( 1 )$$

where the channel's geometry is defined by its cross-sectional area (A), perimeter (P), length (L), width (W), and height (H). The hydraulic diameter (D) is given by 4W·H/2(W+H), and the product of the Reynolds number and friction factor (Re f) is approximated by Kays and Crawford [28] as 13.84+10.38·exp(−3.4/α), where α is the channel's aspect ratio (≧1). Additionally, merging the parallel channels and header segments in a tee junction implicitly adds a resistance term (R_{T}) to a header segment due to the contact area of the tee junction (A_{T}):

$${R}_{T}^{′} = \frac{1}{2} \frac{( Re f ) μ {A}_{T}}{D \cdot A} \qquad ( 2 )$$

In Eq. (2), all geometric parameters take into account the associated header segment [18]. Also note that this model neglects any added tee junction resistance term to the parallel channels due to their length. This assumption is addressed in Section 6.

Using the resultant resistances, we can solve a set of pressure and mass balance equations to determine the flow distribution through the parallel channels of a Z-configuration fuel cell. The pressure and mass balance equations for the Z-configuration presented in FIG. 1 are as follows:

v₁r₁+V₁′R₁′=V₁R₁+v₂r₂ (3a)

v₂r₂+V₂′R₂′=V₂R₂+v₃r₃ (3b)

VᵢₙAᵢₙ=V₁A₁+v₁a₁ (3c)

V₁Aₗ=V₂A₂+v₂a₂ (3d)

V₂A₂=v₃a₃ (3e)

VᵢₙAᵢₙ=V₁A₁+V₁′A₁′=V₂A₂+V₂′A₂′ (3f)

where vᵢ, rᵢ, and aᵢ are the average linear velocity, resistance, and cross-sectional area of the i^{th} parallel channel. Similarly, Vᵢ, Rᵢ, and Aᵢ describe the i^{th} inlet header segment, and Vᵢ′, Rᵢ′, and Aᵢ′ correspond to the i^{th} outlet header segment.

Because each segment is independently defined, it is relatively straightforward to extend the geometry in FIG. 1 to a system with N parallel channels and N−1 inlet and outlet header segments. Moreover, we express Eqs. (3) in matrix form so that a custom computer algorithm can be used to solve for the system's average linear velocities and flow distribution. For brevity, we apply both transformations simultaneously and find the following;

$$\begin{matrix}[ M ] = [ R ] [ V ] & ( 4 a ) \\ where & \\ [ M ] = [ \begin{matrix}- \frac{{V}_{i n} {R}_{1}^{′} {A}_{i n}}{{A}_{1}^{′}} \\ - \frac{{V}_{i n} {R}_{2}^{′} {A}_{i n}}{{A}_{2}^{′}} \\ ⋮ \\ - \frac{{V}_{i n} {R}_{N - 1}^{′} {A}_{i n}}{{A}_{N - 1}^{′}} \\ {A}_{i n} {V}_{i n} \\ 0 \\ ⋮ \\ 0\end{matrix} ] & ( 4 b ) \\ [ R ] = [ \begin{matrix}{r}_{1} & - {r}_{2} & 0 & 0 & … & 0 & - ( {R}_{1} + \frac{{R}_{2}^{′} {A}_{2}}{{A}_{1}^{′}} ) & 0 & 0 & … & 0 \\ 0 & {r}_{2} & - {r}_{2} & 0 & … & 0 & 0 & - ( {R}_{2} + \frac{{R}_{2}^{′} {A}_{2}}{{A}_{2}^{′}} ) & 0 & … & 0 \\ ⋮ & ⋮ & & ⋱ & & ⋮ & ⋮ & ⋮ & ⋱ & & ⋮ \\ 0 & 0 & … & 0 & {r}_{N - 1} & - {r}_{N} & 0 & 0 & … & 0 & - ( \begin{matrix}{R}_{N - 1} + \\ \frac{{R}_{N - 1}^{′} {A}_{N - 1}}{{A}_{N - 1}^{′}}\end{matrix} ) \\ {a}_{1} & 0 & 0 & 0 & … & 0 & {A}_{1} & 0 & … & … & 0 \\ 0 & {a}_{2} & 0 & 0 & … & 0 & - {A}_{1} & {A}_{2} & & & ⋮ \\ 0 & 0 & {a}_{2} & 0 & … & 0 & 0 & - {A}_{2} & & & ⋮ \\ ⋮ & ⋮ & & ⋱ & & ⋮ & ⋮ & 0 & ⋱ & & 0 \\ 0 & 0 & … & … & {a}_{N - 1} & 0 & ⋮ & ⋮ & & - {A}_{N - 2} & {A}_{N - 1} \\ 0 & 0 & … & … & 0 & {a}_{N} & 0 & 0 & … & 0 & - {A}_{N - 1}\end{matrix} ] & ( 4 c ) \\ [ V ] = [ \begin{matrix}{v}_{1} \\ {v}_{2} \\ ⋮ \\ {v}_{S} \\ {V}_{1} \\ {V}_{2} \\ ⋮ \\ {V}_{N}\end{matrix} ] & ( 4 d )\end{matrix}$$

Note that the matrices in Eqs. (4b,c) reduce to those published by Zhang, et al. [18] if the proper substitutions are made.

We constructed an algorithm using the FORTRAN 77 programming language to solve Eqs. (4). Using any set of fluidic and geometric parameters, the program automatically assembled the [M] and [R] matrices using Eqs. (4b,c) and inverts the [R] matrix to form the [R]⁻¹ matrix. The stability of this inversion is tested by outputting the diagnostic det([R][R]⁻¹)=det([I]), which was unity for systems where N=1000. Finally, [R]⁻¹[M] is computed to give the [V] matrix in Eq. (4d). The first N elements of the [V] matrix yield the flow distribution throughout their parallel channels of the specified Z-configuration geometry, which is characterized by an established non-uniformity index [8, 12]:

$${F}_{1} = \frac{max ( {v}_{1} … {v}_{N} ) - min ( {v}_{1} … {v}_{N} )}{max ( {v}_{1} … {v}_{N} )} \qquad ( 5 )$$

In the case of perfectly uniform distribution, F₁=0, and F₁→1 as flow non-uniformity becomes increasingly severe.

### 2.3 Discrete Geometry Optimization

To optimize a Z-type parallel configuration of a fuel cell for flow uniformity, we must make a few assumptions. First, we assume that the flow is perfectly distributed through the parallel channels, i.e., v₁ . . . v_{N}=vₚ in Eqs. (3a-e). We then recognize that the pressure balance equations in Eqs. (3a,b) simplify to;

VᵢRᵢ=Vᵢ′Rᵢ′ (6a)

and the mass-balance equations in Eqs. (3c-e) imply that;

V_{N}A_{N}=vₚaₚ (6b)

V_{N-1}A_{N-1}=V_{N}A_{N}+vₚaₚ=2vₚaₚ (6c)

which can be generalized for the i^{th} inlet header by;

$${V}_{i} = ( N + 1 - i ) \cdot \frac{{a}_{P} {v}_{P}}{{A}_{i}} \qquad ( 6 d )$$

We now make a second assumption that the entire Z-configuration is symmetric (symmetry plane shown in FIG. 1A). Here, the geometry of the i^{th} inlet header is identical to the (N−i)^{th} outlet header. For the geometry in FIG. 1, this means that A₁=A₃′ and A₁′=A₃, which is also true for widths, heights, resistances, and average velocities. By Eq. (6a), this constraint immediately leads to a universal set of solutions by relating the i^{th} and (N+1−i)^{th} inlet headers;

VᵢRᵢ=Vᵢ′=Rᵢ′=V_{N+1+i}R_{N+1-i} (6e)

We then substitute Eq. (6d) on both sides of Eq. (6e) to give;

$$( N + 1 - i ) \cdot \frac{{a}_{P} {v}_{p} {R}_{i}}{{A}_{i}} = i \cdot \frac{{a}_{P} {v}_{P} {R}_{N + 1 - i}}{{A}_{N + 1 - i}} \qquad ( 7 )$$

which reduces to

$$\frac{{R}_{i}}{{A}_{i}} = \frac{i}{( N + 1 - i )} \cdot \frac{{R}_{N + 1 - i}}{{A}_{N + 1 - i}} \qquad ( 8 )$$

The R/A ratio for a header segment is given by simplification of Eqs. (1) and (2);

$$\frac{R}{A} = \frac{μ L ( 13.84 + 10.38 \cdot {e}^{- \frac{5.4 W}{H}} ) {( W + H )}^{2}}{2 \cdot {W}^{3} {H}^{3}} + \frac{μ {A}_{T} ( 13.84 + 10.38 \cdot {e}^{- \frac{5.4 W}{H}} ) ( W + H )}{4 \cdot {W}^{3} {H}^{3}} \qquad ( 9 )$$

assuming that the segment's aspect ratio is given by W/H, i.e., W/H≦1.

Eq. (8) is the key to our optimization method because it relates the first 1 . . . N/2 inlet headers to the last N/2 . . . N−1 inlet headers. Practically, we can change the dimensions of the 1 . . . N/2 inlet headers with respect to the N/2 . . . N−1 inlet headers to satisfy Eq. (8). It is entirely possible to vary header heights to satisfy Eq. (8), but this approach could generate several problems. If the parallel channels heights are not altered to match the header heights, reagent must flow over an additional surface from deeper inlet headers to shallower parallel channels, and this could induce significant minor losses at higher Reynolds numbers similar to those observed in Section 6 of this publication and unknown effects on the flow distribution. However, if the parallel channel heights are altered, this could negatively impact optimal power generation in the parallel channels as shown by Kumar, et al. [5, 25]. Therefore, we chose to alter the headers' widths to satisfy Eq. (8).

There are infinite solutions to the outlined R/A relationships; some constraint must be emplaced to arrive at a unique solution, which we arbitrarily assigned as a minimized footprint herein. Thus, we begin by setting the widths of the N/2 . . . N−1 headers with the same dimensions as the parallel channels, which propagates to an optimized geometry with a minimal footprint, unless the N/2 . . . N−1 headers are narrowed further. It should be noted that if the widths of the N/2 . . . N−1 headers are increased, all widths will increase, and this technique can be used as a tool to reduce Reynolds numbers throughout the headers and the corresponding minor losses, distribution asymmetry, and parasitic pressure drops illustrated in Section 6. In other applications, we have written algorithms to limit parameters such as Reynolds number or fluidic shear stress throughout the header channels by stipulating that Eq. (8) must be satisfied and flow through all header satisfies the secondary condition. Practically, this is implemented by wrapping the width optimization algorithm detailed later in this section by a similar algorithm stipulating the secondary condition. These applications were equally successful and resulted in alternative, more linear, header shapes unique to these restrictions.

Next, the geometries of the first 1 . . . N/2 inlet headers are set to satisfy the relation in Eq. (8), which involves increasing their width and/or height relative to the last N/2 . . . N−1 inlet headers. Note that if there are an odd number of parallel channels, the middle N/2 inlet header, which is not related to any other, is simply assigned the geometry of the last N/2+1 inlet header.

Since Eq. (9) is far from a simple expression relating W to R/A, it is not trivial to fit a universal expression to approximate the set of Wᵢ for any geometry since there are also dependencies on channel height and length. Rather, we wrote a simple search algorithm to find Wᵢ for the first 1 . . . N/2 inlet headers by the following operations:
(1) For the

$$\frac{N}{2} … N - 1$$

inlet headers, calculate the R/A ratios, and set the target R/A ratios for the 1 . . . N/2 inlet headers by Eq. (8). All subsequent steps regard the 1 . . . N/2 inlet headers.
(2) Set Wᵢ equal to zero, and an initial step size of 1 mm.
(3) Add a step to the initial Wᵢ and recalculate Rᵢ/Aᵢ via Eq. (9).
(4) If the new Rᵢ/Aᵢ is greater than the result from step (1), add another step increment and repeat step (2).
(5) If the new Rᵢ/Aᵢ is less than the target from step (1), take one step back and decrease the step size by a factor of 10. Proceed with step (2) unless the new step size is less than a specified tolerance increment. If the tolerance limit has been reached, compare Rᵢ/Aᵢ as is to Rᵢ/Aᵢ with an added tolerance step, and choose the value closest to the target. In this study, we specified the tolerance increment at 0.01 mm to reflect fabrication limits [2].
(6) Set the i^{th} outlet header width equal to the (N+1−i)^{th} inlet header width.

The program described in Section 2.2 was modified to include this search algorithm and solve for both the initial and optimized flow profiles. We analyzed a 175 channel Z-configuration with an Intel i7-3517U CPU in only 2.625 s CPU time. Moreover, with UNC-Chapel Hill's KillDevil supercomputing cluster running an Intel Xeon X5650 CPU, we analyzed a 1,000 channel configuration in 376.060 s of CPU time.

### 2.4 CFD Modeling

As a matter of validation, we used COMSOL Multiphysics® 4.3a to conduct CFD simulations of both oxygen and hydrogen flow distributions through Z-type configuration designs. Geometries were constructed within COMSOL as two-dimensional to ensure numerical tractability. To account for this approximation, a volumetric drag term was added to the velocity field (u), F_{μ}=−12 μu/H². The validity of this volumetric drag term was affirmed by comparison with a three-dimensional model of geometry I defined in Section 3 (data not shown). Elongated inlets and outlets were used to stabilize flow profiles prior to flow encountering the parallel channels.

A faux internal boundary was drawn across the middle of the parallel channels. This boundary had no effect except to ensure that the meshing algorithm assigned data points along this boundary in each channel, which were used to construct velocity line plots. Solutions were obtained via meshing and solving with custom settings within COMSOL. Excluding points that defined the wall, data was averaged to generate the linear velocity through a parallel channel. To account for small deviations caused by extracting the vᵢ data in this manner, sets of vᵢ from both discrete and CFD solutions were normalized with respect to the average linear velocity over all vᵢ. Pressure drops were calculated using two lines across the inlet and outlet channels, which were directly adjacent to the first and last parallel channel, respectively, to account for the elongated inlets and outlets. The maximum pressure of the inlet line was subtracted from the minimum of the outlet line.

Meshing: The maximum element size, minimum element size, and maximum element growth rate were 0.25 mm, 10.3 mm, and 1.04, respectively; the resolutions of curvature and narrow regions were 0.1 and 16, respectively. The geometries presented herein consisted of approximately 150,000 to 600,000 elements.

Solving: Systems were solved using the PARDISO algorithm, the Double-Dogleg nonlinear solver, automatic pseudo-time stepping, and a relative tolerance that was minimized for each geometry to ensure convergence to a unique solution in all cases. For the largest 25-channel geometry, it took 4,111 s of CPU time using an Intel i7-3770K processor.

Optimized geometries from discrete solutions in Section 2.3 were constructed within COMSOL by fitting cubic functions through each header segment at the branching tee junctions. This resulted in a smooth transition between the widths, thereby avoiding abrupt changes in fluid flow and minor losses due to sudden contractions. It must be noted that while the cubic function resulted in well distributed flow (see Section 4), this adaptation was empirical. It is entirely plausible that there are alternative methods of fitting the sets of header widths that better match the discrete optimization results. Moreover, potential deviations in the fabrication of these curvatures and their impact on flow distribution warrant future experimental validation.

### 3. Validation

Using both discrete (Section 2.2) and CFD (Section 2.4) methods, we assessed oxygen flow distributions for three published Z-configuration geometries [8, 18] that are parameterized in Table 1 and FIG. 2. For comparability, all inlet velocities were set so that the average parallel channel velocity should be 0.1 m s⁻¹ [8] if perfectly distributed, i.e., Vᵢₙ=(Σᵢ₌₁^{N}aᵢ)/Aᵢₙ·0.1 m s⁻¹.

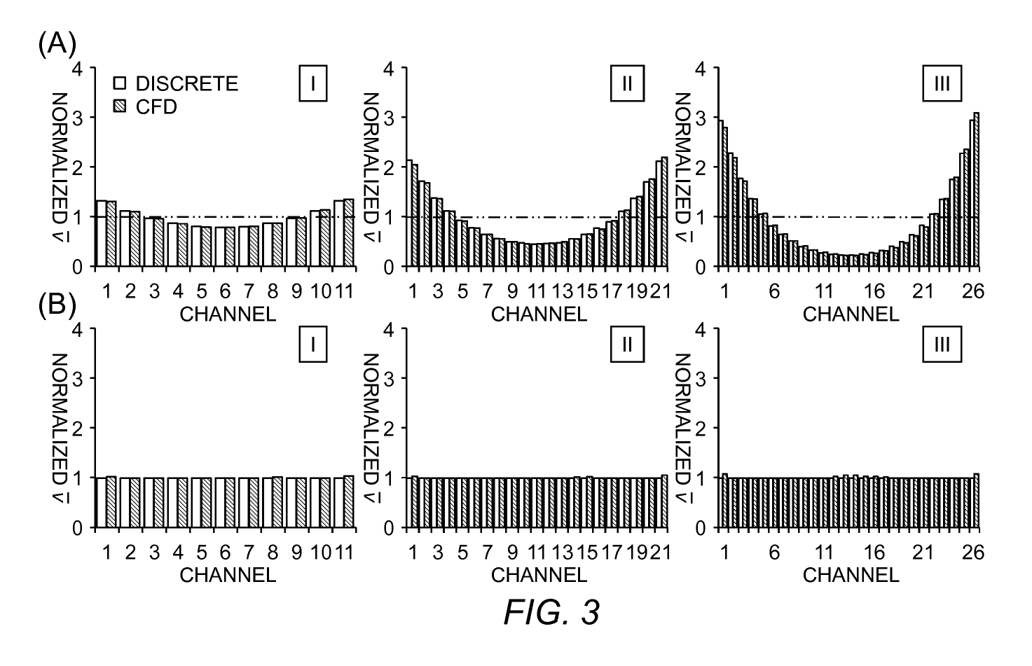

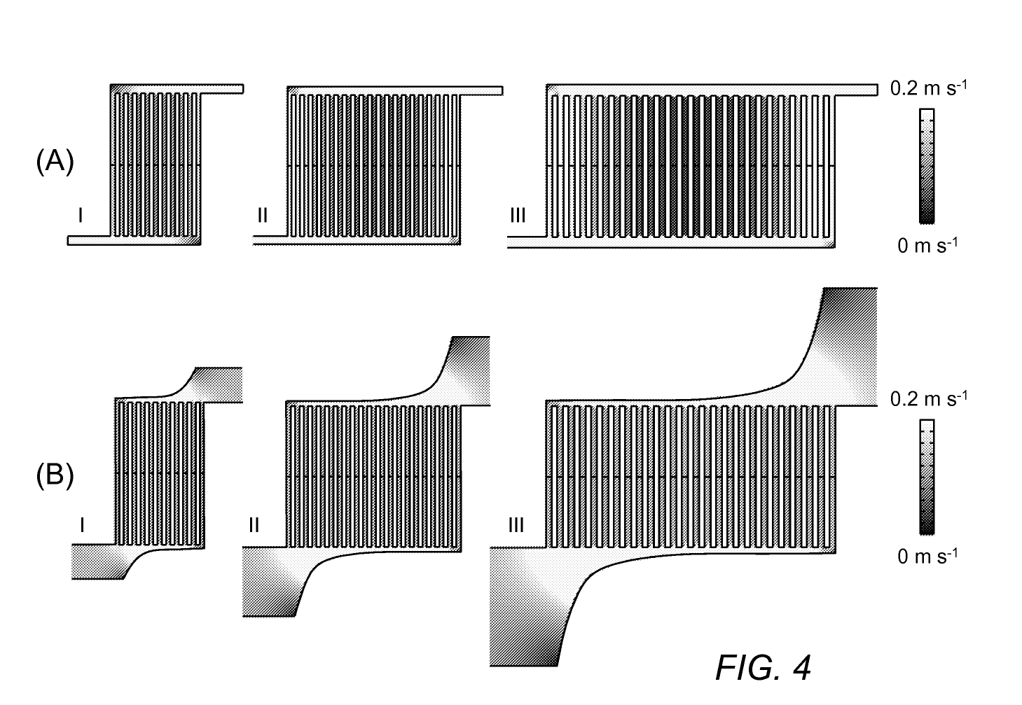

Flow distributions of geometries I-III are shown in FIG. 3A, and CFD velocity surfaces are shown in FIG. 4A. Both sets of F₁ parameters, calculated by Eq. (5) and shown in Table 1, are nearly identical between discrete and CFD results. Additionally, these results coincide with previously published results [8, 18], all of which validates the discrete method for these geometries.

### 4. Geometry Optimization

We applied the discrete optimization code in Section 2.3 to geometries I-III and adapted the resultant inlet and outlet header widths to the CFD simulations as described in Section 2.4. The F₁ parameters, inlet widths, and percent changes in the pressure required to drive the system from CFD solutions are shown in Table 2. The optimized flow profiles from discrete and CFD solutions are shown in FIG. 3B, and the CFD velocity profiles are presented in FIG. 4B.

After optimization, we have significantly reduced flow maldistribution in geometries I-III, where the oxygen flow F1 parameters decreased by 86% on average. Additionally, the parasitic pressure required to drive these optimized geometries is either slightly reduced or essentially unaffected (see Table 2). Thus, this optimization method is effective, simply devised for any given system via the relations in Section 2.3, does not change any geometric parameters of the parallel channels that could affect reaction efficiencies, and offers improved scalability over previous optimization methods [23, 24], which is immediately evident from the CPU times in Sections 2.3 and 2.4 that were required to solve for velocity fields and would be further improved by more advanced algorithms than the simplified search algorithm outlined in Section 2.3.

### 5. Minimizing Footprint of Optimized Geometries.

As can be seen in FIG. 4, geometry III's footprint increased substantially after optimization. While the optimized header width is on the order of stack manifold headers [29] and likely not an issue for fabrication, it is inevitable that during scale-up, the optimized Z-configuration's footprint could increase beyond tolerable limits or the stack manifolds could become too large. To address this potential issue, we evaluated several avenues by which the leading header widths and total footprint can be minimized without perturbing the uniform flow in the parallel channels.

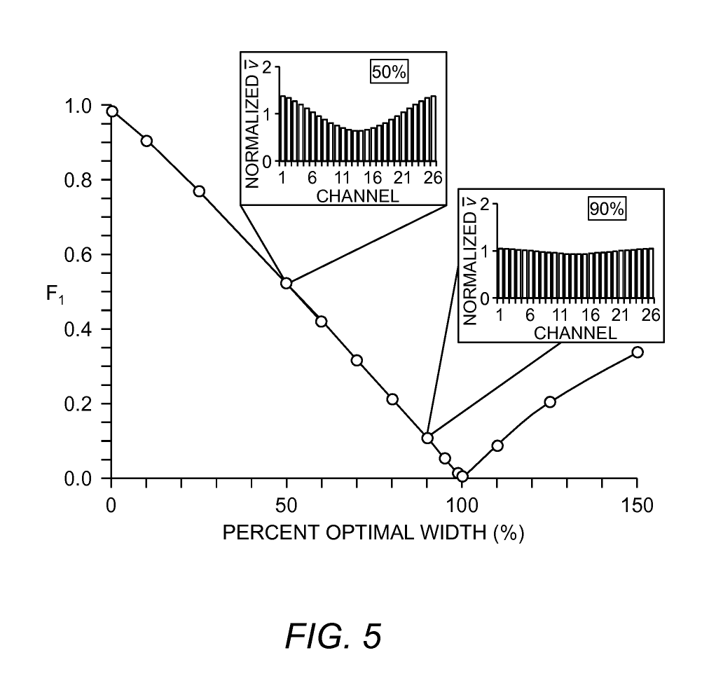

First, rather than applying the exact widths satisfying Eq. (8), we increased geometry III's headers by different percentages of these optimized widths to determine if we could apply a less exact geometry optimization with a smaller footprint but still yield a uniform flow distribution. The discrete results from applying various percentages of the optimal widths to geometry III are shown in FIG. 5. Note that these percentages regard the increases in widths of the 1 . . . N/2 headers relative to the widths of the N/2 . . . N −1 headers (see Section 2.3). Applying 80% of the optimal widths increased the F₁ parameter from 0.01 to 0.21, but applying 90% resulted in an F₁ of 0.11, which is within the ±5% deviation that has been previously defined as an acceptable tolerance for flow non-uniformity [22].

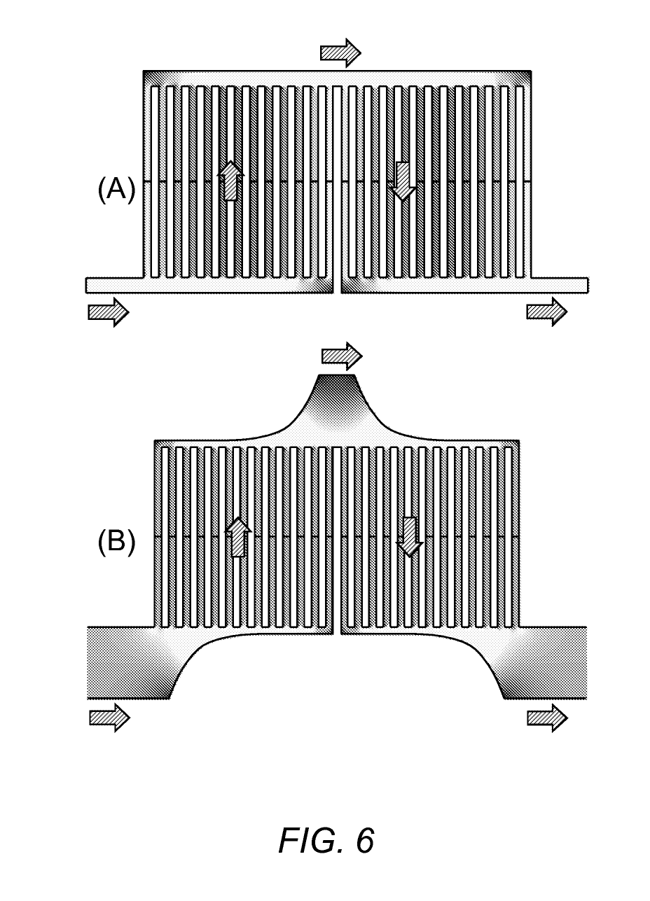

Second, discontinuous designs may be applied to optimized geometries in order to reduce the fuel cell's footprint. For example, a discontinuous geometry III is shown in FIG. 6A. It is clear that the fundamental maldistribution profiles are still present. Even smaller discontinuous subsets of geometry III would be necessary to further reduce the magnitude of non-uniformity, but again, this optimization technique would result in increased parasitic pressure [3]. However, if we connect optimized subsets of geometry III in a discontinuous fashion (FIG. 6B), maldistribution, pressure, and overall footprint is reduced.

Lastly, channel heights could be increased throughout the entire geometry to minimize the optimized geometry's overall footprint. This necessitates smaller increases in header widths to produce larger decreases in the R/A ratio in Eq. (9). If geometry III's depth is increased to 1.5 mm, which has been suggested as optimal for hydrogen consumption [25], the optimized leading inlet width then decreases from 41.72 mm to 30.71 mm. This technique is limited because further increases in channel height could reduce reaction efficiency in the parallel channels. Also, changes in the headers' hydraulic diameter and inlet linear velocity may increase Reynolds numbers throughout the inlets, which can cause flow to recirculate at the branching tee junctions and asymmetry in the flow distribution due to the minor losses described in Section 6.

### 6. Minor Losses

As mentioned in Section 2.2, resistances within the discrete model only concern major pressure drops to viscous drag. In cases where Reynolds numbers are large enough to induce flow recirculation in the branching tee junctions, the minor loss pressure drops, asymmetric skew in flow distributions, and reagent imbalance between the cathode and anode will not be predicted by this model [3, 22, 26, 27]. We must explicitly state that it is not a trivial task to describe minor losses occurring in branching and combining tee junctions in the algorithms in Section 2.2. Minor effects are a function of the ratio of velocities between the branched and combined flow [26], whereas velocities are individually defined in the [V] matrix. Including minor effects would require reformulating the entire discrete model.

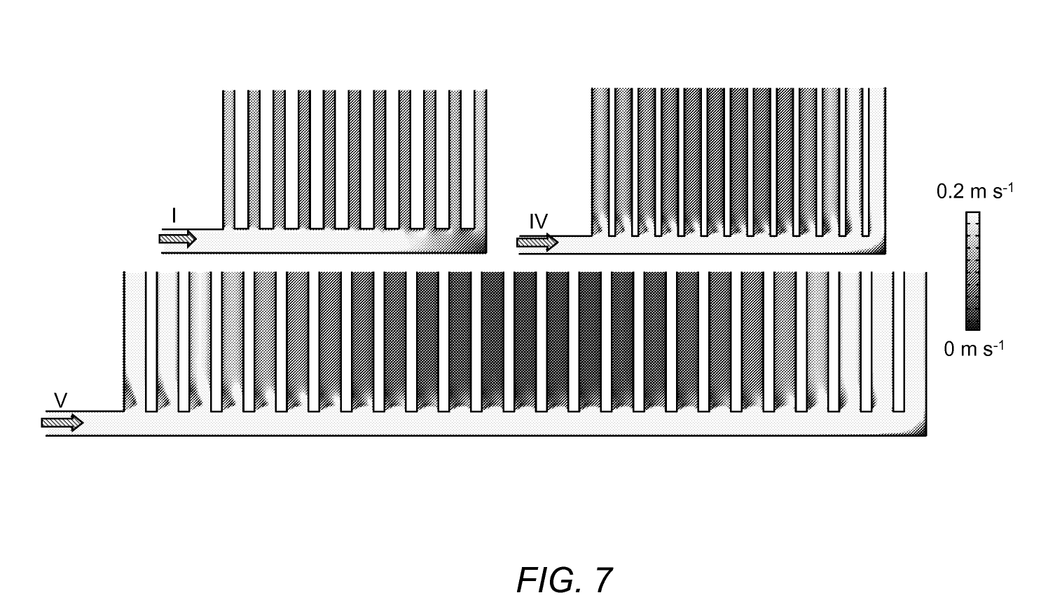

To demonstrate this issue, we evaluated geometries IV and V that are parameterized in Table 3. Geometry IV was a Z-configuration adapted from channel dimensions optimized for hydrogen consumption by Kumar, et al. [25], and geometry V was adapted from a commercially available Z-configuration fuel cell studied by Iranzo, et al. [2]. To achieve 0.1 m s⁻¹ oxygen flow in the parallel channels of geometries IV and V, the Reynolds numbers at the inlets were 129 and 140, respectively, and in FIG. 7, we show flow recirculation developing along the branching tee junctions (experimentally demonstrated by Barreras, et al. [19]). These results are contrasted to geometry I in FIGS. 4A and 7, where the Reynolds number at the inlet was only 37, and no recirculation was observed.

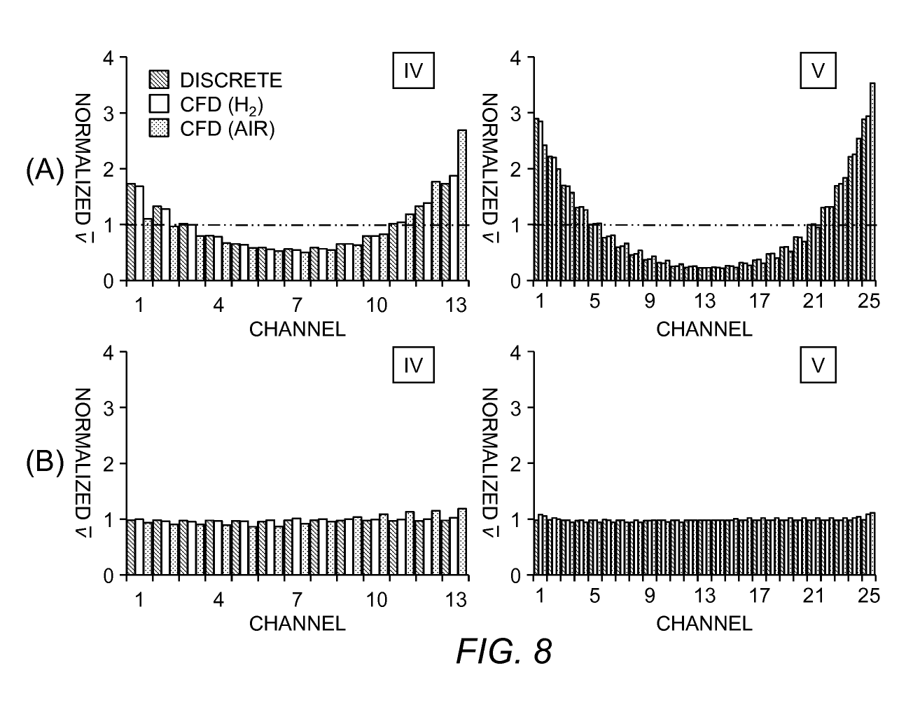

As the fluid's velocity and Reynolds number decreases along the inlet headers, recirculation and the accompanying minor loss pressure drops decrease in magnitude [26]. Thus, parallel channels farther from the inlet are biased with a lower resistance and faster flow through the parallel channels, thereby modulating the discrete model's parabolic shape to generate the asymmetric distributions shown in FIG. 8A. Thus, for geometry I, no significant oxygen flow distribution asymmetry was observed, and geometries II and III, which have inlet Reynolds numbers of 70 and 105, respectively, showed slight asymmetry forming in the oxygen flow distributions (see FIG. 3A).

To quantitate these effects, we define a new flow asymmetry parameter:

$${F}_{2} = \frac{\vert max ( {v}_{1} … {v}_{\frac{N}{2}} ) - max ( {v}_{\frac{N}{2}} … {v}_{N} ) \vert}{max ( {v}_{1} … {v}_{N} )} \qquad ( 17 )$$

In all discrete calculations, F₂ will be zero as the flow distribution is always symmetric. But in CFD simulations, F₂→1 as asymmetry and minor losses become more problematic. For geometries IV and V, both F₁ and F₂ parameters are shown in Table 4 along with CFD pressure drops. As a note, geometries I, II, and III in FIG. 4A have oxygen flow F₂ parameters of 0.03, 0.07, and 0.10, respectively.

Hydrogen flow profiles are less skewed and more closely match discrete results since hydrogen's kinematic viscosity and Reynolds numbers are an order of magnitude less than oxygen's. As noted previously, this creates reagent imbalance between the cathode and anode that can negatively impact a fuel cell's efficiency [3]. As expected, hydrogen flow F₂ parameters for these geometries are <0.01 for all cases.

Even though these minor losses are not described in the discrete model detailed in Section 2.2 or the optimization method in Section 2.3, the increased header widths in optimized geometries inadvertently reduce these minor losses by reducing Reynolds numbers due to slower reagent flow, which outweighs increasing hydraulic diameters. For example, after optimizing geometries IV and V, pressures were reduced to about half as the minor loss pressure drops lessened. The F₂ parameters of geometries I-III were all reduced to 0.02 after optimization, and these asymmetry parameters of geometries IV and V were also reduced, albeit not to the same extent. As mentioned in Section 2.3, rather than constrain optimization results by minimized footprint (by restraining the N/2 . . . N−1 headers to the parallel channel width), it is quite straight forward to sequentially increase the N/2 . . . N−1 headers until flow through the optimized corresponding header has a Reynolds number less than a specified value, such as 100.

TABLE 1
Geometric parameters (units: mm), F₁ parameters from discrete and CFD results,
CFD pressure drops (units: Pa), and references for geometries I-III.

| | Discrete | CFD | | Parallel Channel Properties | | | | Rib | Inlet | Inlet | |
|---|---|---|---|---|---|---|---|---|---|---|---|
| Geometry | F₁ | F₁ | ΔP | Number | Length | Width | Height | Width | Width | Height | Ref. |
| I | 0.40 | 0.41 | 11.1 | 11 | 50.00 | 1.50 | 0.60 | 1.50 | 3.00 | 0.60 | 18 |
| II | 0.78 | 0.79 | 30.1 | 21 | 50.00 | 1.50 | 0.60 | 1.50 | 3.00 | 0.60 | 18 |
| III | 0.92 | 0.92 | 39.6 | 26 | 50.00 | 2.00 | 0.72 | 2.00 | 4.00 | 0.72 | 8 |

TABLE 2
Optimized geometries' inlet widths (units: mm), F₁ parameters
calculated via discrete and CFD analyses, and CFD pressure drops
(units: Pa) and their percent decrease relative to initial geometries.

| | | |
|---|---|---|
| Inlet | Discrete | CFD |

| Geometry | Width | F₁ | F₁ | ΔP | ΔΔP (%) |
|---|---|---|---|---|---|
| I | 12.28 | 0.00 | 0.06 | 10.4 | −6.8 |
| II | 24.37 | 0.00 | 0.09 | 30.0 | −0.3 |
| III | 41.72 | 0.01 | 0.14 | 39.3 | −0.6 |

TABLE 3
Geometric parameters (units: mm) and references for geometries IV-V.

| | Parallel Channel Properties | | | | Rib | Inlet | Inlet | |
|---|---|---|---|---|---|---|---|---|
| Geometry | Number | Length | Width | Height | Width | Width | Height | Ref. |
| IV | 13 | 37.00 | 1.50 | 1.50 | 0.50 | 1.50 | 1.50 | 25 |
| V | 25 | 72.25 | 2.00 | 0.80 | 0.80 | 2.00 | 0.80 | 2 |

TABLE 4
F₁ parameters from discrete and CFD analyses, and CFD oxygen and
hydrogen flow distribution F₂ parameters and pressure drops (units: Pa).

| | Discrete | CFD (H₂) | | | CFD (oxygen) | | |
|---|---|---|---|---|---|---|---|
| Geometry | F₁ | F₁ | F₂ | ΔP | F₁ | F₂ | ΔP |
| IV | 0.67 | 0.70 | 0.10 | 2.2 | 0.80 | 0.59 | 5.7 |
| V | 0.92 | 0.92 | 0.03 | 21.2 | 0.93 | 0.31 | 48.0 |

TABLE 5
Optimized geometries' inlet widths (units: mm), F₁ parameters calculated via
discrete and CFD analyses, and CFD ΔP pressure drops (units: Pa) and their percent decrease
relative to initial geometries

| | Inlet | Discrete | CFD (H₂) | | | | CFD (oxygen) | | | |
|---|---|---|---|---|---|---|---|---|---|---|
| Geometry | Width | F₁ | F₁ | F₂ | ΔP | ΔΔP (%) | F₁ | F₂ | ΔP | ΔΔP (%) |
| IV | 9.86 | 0.00 | 0.06 | 0.02 | 1.2 | −46 | 0.27 | 0.21 | 2.7 | −53 |
| V | 41.23 | 0.00 | 0.10 | 0.01 | 11.2 | −47 | 0.14 | 0.05 | 23.7 | −51 |

### 7. Conclusions

Uniform delivery of reagents to the Z-configuration's parallel channels is imperative for optimum performance of a fuel cell stack [2-5, 7-20]. We modified a simple discrete method to assess flow maldistribution and deduced a mathematical relationship for, in this study, increasing header widths to optimize the flow distribution. We have presented cases that show both the accuracy of the discrete method, the success of optimization at reducing flow maldistribution, and the reduction of parasitic minor loss pressure drops and the corresponding flow distribution asymmetry, even though these phenomena were not described explicitly. In all of these optimizations, the parallel channel's geometry, which is often already optimized for reaction efficiency, is not altered, and solutions are obtained with computational ease. To the best of our knowledge, this represents the first time a model has been described to curb flow maldistribution that is universally applicable to all Z-type configurations of planar fuel cells [22]. In summary, three main benefits of our optimization method are apparent: (i) Simplicity and scalability; (ii) flow uniformity universal to any Z-type geometry; and (iii) reduction of parasitic minor loss pressure drops and asymmetry in flow distributions.

A potential drawback of this method is that headers may become too wide and occupy too much space for a compact fuel cell. To counter this, we have shown several ways to implement this geometry optimization that reduce the footprint of the optimized device while retaining well-distributed flow. We have also presented cases in which the discrete method fails to predict asymmetry in the flow distribution. While we did not alter the discrete method to compensate for this asymmetry, we elucidated that this phenomenon was caused by minor losses, namely recirculation of the flow field at the inlet tee junctions at Reynolds numbers >100. These shortcomings provide a frame of reference for gauging the applicability of discrete solutions and reducing these unwanted pressure drops at the tee junctions and their negative impact on flow distribution symmetry.

With regards to future research, we have identified areas such as the smoothing of the inlet headers using cubic functions and the need for experimental validation. Furthermore, this research is equally significant in the design of fuel cell stack manifolds, where reagent delivery between layers of the stack exhibits similar maldistribution [30]. If one treats each layer as an individual fluidic resistor, the mathematics described herein are well suited to curbing reagent maldistribution in Z-type configurations of fuel cell stacks, which would be very difficult using previously demonstrated optimization algorithms [23, 24].

We would also like to note that these algorithms are also applicable to other applications that utilize this Z-type configuration, such as the high throughput processing of samples searching for rare events. We are currently applying the same algorithms described here to increase the throughput of microfluidic devices that process whole blood patient samples and select metastatic circulating tumor cells. The rarity of these cells (1 to 100 per mL blood) necessitates processing several mL of blood in a microfluidic device, and these optimized geometries permit device scale-up for rapid sample throughput while uniformly retaining the optimal fluid dynamics for isolating rare cells throughout all parallel channels [31-33].

### REFERENCES

[1] X. Li, I. Sabir, Int. J. Hydrogen Energy, 30 (2005) 359-371.
[2] A. Iranzo, M. Muñoz, F. Rosa, J. Pino, Int. J. Hydrogen Energy, 35 (2010) 11533-11550.
[3] S. Maharudrayya, S. Jayanti, A. P. Deshpande, J. Power Sources, 157 (2006) 358-367.
[4] D. Tondeur, Y. Fan, J.-M. Commenge, L. Luo, Chem. Eng. Sci., 66 (2011) 2568-2586.
[5] A. P. Manso, F. F. Marzo, J. Barranco, X. Garikano, M. Garmendia Mujika, Int. J. Hydrogen Energy, 37 (2012) 15256-15287.
[6] J. Wang, Int. J. Hydrogen Energy, 33 (2008) 6339-6350.
[7] J. Wang, Int. J. Hydrogen Energy, 35 (2010) 5498-5509.
[8] S. Maharudrayya, S. Jayanti, A. P. Deshpande, J. Power Sources, 144 (2005) 94-106.
[9] T. Dey, P. C. Ghosh, D. Singdeo, M. Bose, R. N. Basu, Int. J. Hydrogen Energy, 36 (2011) 9967-9976.
[10] H. M. Jung, W. Y. Lee, J. S. Park, C. S. Kim, Int. J. Hydrogen Energy, 29 (2004) 945-954.
[11] G. Karimi, J. J. Baschuk, X. Li, J. Power Sources, 147 (2005) 162-177.
[12] R. J. Kee, P. Korada, K. Walters, M. Pavol, J. Power Sources, 109 (2002) 148-159.
[13] J.-H. Koh, H.-K. Seo, C. G. Lee, Y.-S. Yoo, H. C. Lim, J. Power Sources, 115 (2003) 54-65.
[14] Z. Ma, S. M. Jeter, S. I. Abdel-Khalik, J. Power Sources, 108 (2002) 106-112.
[15] Z. Ma, S. M. Jeter, S. I. Abdel-Khalik, Int. J. Hydrogen Energy, 28 (2003) 85-97.
[16] S. Shimpalee, J. W. Van Zee, Int. J. Hydrogen Energy, 32 (2007) 842-856.
[17] Y. Sung, J. Power Sources, 157 (2006) 395-400.
[18] W. Zhang, P. Hu, X. Lai, L. Peng, J. Power Sources, 194 (2009) 931-940.
[19] F. Barreras, A. Lozano, L. Valiño , C. Marín, A. Pascau, J. Power Sources, 144 (2005) 54-66.
[20] D. Martín, D. M. Guinea, B. Moreno, L. González, M. C. García-Alegre, D. Guinea, Int. J. Hydrogen Energy, 32 (2007) 1572-1581.
[21] M. Secanell, J. Wishart, P. Dobson, J. Power Sources, 196 (2011) 3690-3704.
[22] L. G. J. de Haart, M. Spiller, FUEL CELLS—SOLID OXIDE FUEL CELLS|Gas Distribution, in: G. Jürgen (Ed.), Encyclopedia of Electrochemical Power Sources, Elsevier, Amsterdam, 2009, pp. 77-87.
[23] N. Guo, M. C. Leu, U. O. Koylu, International Journal of Hydrogen Energy, 38 (2013) 6750-6761.
[24] R. Manikanda Kumaran, G. Kumaraguruparan, T. Sornakumar, Applied Thermal Engineering, 58 (2013) 205-216.
[25] A. Kumar, R. G. Reddy, J. Power Sources, 113 (2003) 11-18.
[26] J. Wang, Chem. Eng. J., 168 (2011) 1331-1345.
[27] B. Chernyaysky, P. C. Sui, B. S. Jou, N. Djilali, Int. J. Hydrogen Energy, 36 (2011) 7136-7151.
[28] W. M. Kays, M. E. Crawford, Convective Heat and Mass Transfer, 2d ed., McGraw-Hill, New York, 1980.
[29] C.-H. Chen, S.-P. Jung, S.-C. Yen, J. Power Sources, 173 (2007) 249-263.
[30] W. L. Huang, Q. Zhu, J. Power Sources, 178 (2008) 353-362.
[31] J. M. Jackson, M. A. Witek, M. L. Hupert, C. Brady, S. Pullagurla, J. Kamande, R. D. Aufforth, C. J. Tignanelli, R. J. Torphy, J. J. Yeh, S. A. Soper, Lab Chip, 14 (2014) 106-117.
[32] J. W. Kamande, M. L. Hupert, M. A. Witek, H. Wang, R. J. Torphy, U. Dharmasiri, S. K. Njoroge, J. M. Jackson, R. D. Aufforth, A. Snavely, J. J. Yeh, S. A. Soper, Anal. Chem (2013).
[33] A. A. Adams, P. I. Okagbare, J. Feng, M. L. Hupert, D. Patterson, J. Gottert, R. L. McCarley, D. Nikitopoulos, M. C. Murphy, S. A. Soper, J. Am. Chem. Soc., 130 (2008) 8633-8641.

The foregoing is illustrative of the present invention, and is not to be construed as limiting thereof. The invention is defined by the following claims, with equivalents of the claims to be included therein.

1. A fluid array, comprising:
(a) a fluid input header,
(b) a fluid output header, and
(c) a plurality (N) of at least 26 parallel fluid channels, each of said fluid channels connected to both said fluid input header and said fluid output header in a Z-array configuration;
each of said fluid input and fluid output headers comprising a terminal channel followed by a plurality (N−1) of segments, with each of said segments forming a junction with a corresponding one of said parallel channels, and with each of said segments having a length (L), a width (W), a height (H), and a contact area (A_{T}) at said junction;
with the resistance-to-area ratio (R/A) of each of said (i) input header segments given by Equation A:
$$\frac{{R}_{i}}{{A}_{i}} = {∝}_{i} \cdot \frac{i}{( N + 1 - i )} \cdot \frac{{R}_{N + 1 - i}}{{A}_{N + 1 - i}} \qquad ( A )$$
and with the resistance-to-area ratio (R/A) of each of said (j) output header segments given by Equation B:
$$\frac{{R}_{j}}{{A}_{j}} = {∝}_{j} \cdot \frac{( N + 1 - j )}{j} \cdot \frac{{R}_{N + 1 - j}}{{A}_{N + 1 - j}} \qquad ( B )$$
and the R/A of each of said segments given by Equation C:
$$\frac{R}{A} = \frac{μ \cdot L \cdot Re \cdot f \cdot {( W + H )}^{2}}{2 \cdot {W}^{3} \cdot {H}^{3}} + \frac{μ \cdot {A}_{T} \cdot Re \cdot f \cdot ( W + H )}{4 \cdot {W}^{3} \cdot {H}^{3}} \qquad ( C )$$
where μ is the fluid's viscosity, Re is the Reynolds number, and f is the friction factor;
and with W and/or H in at least 70 percent of said segments configured to satisfy Equation A and Equation B with ∝ within 0.2 to 2 and give a flow non-uniformity index F₁ of less than 0.3 according to Equation D:
$${F}_{1} = \frac{max ( {v}_{1} \text{:} {v}_{N} ) - min ( {v}_{1} \text{:} {v}_{N} )}{max ( {v}_{1} \text{:} {v}_{N} )} \qquad ( D )$$
and/or a relative standard deviation of v₁:v_{N} less than 25 percent, where vᵢ is the fluid's average velocity in the i^{th} parallel channel.

2. The array of claim 1, wherein said parallel channels are linear, curved, inverse curved, or a combination thereof.

3. The array of claim 1, wherein said plurality (N) of parallel fluid channels comprises 26 to 5,000 parallel channels.

4. The array of claim 1, wherein said array is formed in an inorganic substrate or a polymer substrate.

5. The fluid array of claim 1, wherein said fluid is a liquid or gas.

6. The array of claim 1, wherein at least some, a major portion, or all of said parallel channels have a binding ligand immobilized therein.

7. The array of claim 1, wherein said array comprises a fluid channel array for a heat exchanger.

8. The array of claim 1, wherein said array comprises a fuel channel array or an oxygen channel array for a fuel cell electrode-electrolyte assembly (MEA) layer.

9. A method of detecting a first member of a binding pair in a liquid sample by (a) passing the fluid through a microarray having a second member of a binding pair immobilized therein, and (b) detecting the binding of said first member to said second member in said array, wherein an array of claim 1 is used as said microarray.

10. A method of transferring heat to or from a coolant or refrigerant fluid by circulating the fluid through a fluid channel array in a heat exchanger in a heat-transfer effective amount, wherein an array of claim 1 is used as said fluid channel array.

11. A method of circulating fuel or oxygen through a fuel or oxygen channel array in a fuel cell in an energy-generating effective amount, wherein an array of claim 1 is used as said array in which said fuel or oxygen is circulated.

12. A fuel cell comprising:
(a) a primary fuel inlet header;
(b) a primary fuel outlet header;
(c) a primary oxygen inlet header; and
(d) a primary oxygen outlet header;
(e) a plurality of at least 10 membrane electrode assembly (MEA) layers, each of said layers comprising:
a semipermeable membrane,
a plurality of fuel channels on one side of said semipermeable membrane,
a plurality of oxygen channels on the opposite side of said semipermeable membrane,
a secondary fuel inlet header and a secondary fuel outlet header, each in fluid communication with said plurality of fuel channels; and
a secondary oxygen inlet header and a secondary oxygen outlet header, each in fluid communication with said plurality of oxygen channels; with:
(f) each of said primary fuel input and primary fuel output headers comprising a terminal channel followed by a plurality (N−1) of segments, with each of said segments forming a junction with a corresponding one of said parallel channels, and with each of said segments having a length (L), a width (W), a height (H), and a contact area (A_{T}) at said junction;
with the resistance-to-area ratio (R/A) of each of said (i) input header segments given by Equation A:
$$\frac{{R}_{i}}{{A}_{i}} = {∝}_{i} \cdot \frac{i}{( N + 1 - i )} \cdot \frac{{R}_{N + 1 - i}}{{A}_{N + 1 - i}} \qquad ( A )$$
and with the resistance-to-area ratio (R/A) of each of said (j) output header segments given by Equation B:
$$\frac{{R}_{j}}{{A}_{j}} = {∝}_{j} \cdot \frac{( N + 1 - j )}{j} \cdot \frac{{R}_{N + 1 - j}}{{A}_{N + 1 - j}} \qquad ( B )$$
and the R/A of each of said segments given by Equation C:
$$\frac{R}{A} = \frac{μ \cdot L \cdot Re \cdot f \cdot {( W + H )}^{2}}{2 \cdot {W}^{3} \cdot {H}^{3}} + \frac{μ \cdot {A}_{T} \cdot Re \cdot f \cdot ( W + H )}{4 \cdot {W}^{3} \cdot {H}^{3}} \qquad ( C )$$
where μ is the fluid's viscosity, Re is the Reynolds number, and f is the friction factor;
and with W and/or H in at least 70 percent of said segments configured to satisfy Equation A and Equation B with ∝ within 0.2 to 2 and give a flow non-uniformity index F₁ of less than 0.3 according to Equation D:
$${F}_{1} = \frac{max ( {v}_{1} \text{:} {v}_{N} ) - min ( {v}_{1} \text{:} {v}_{N} )}{max ( {v}_{1} \text{:} {v}_{N} )} \qquad ( D )$$
and/or a relative standard deviation of v₁:v_{N} less than 25 percent, where vᵢ is the fluid's average velocity in the i^{th} parallel channel; and/or
(g) each of said primary oxygen input and primary oxygen output headers comprising a terminal channel followed by a plurality (N−1) of segments, with each of said segments forming a junction with a corresponding one of said parallel channels, and with each of said segments having a length (L), a width (W), a height (H), and a contact area (A_{T}) at said junction;
with the resistance-to-area ratio (R/A) of each of said (i) input header segments given by Equation A:
$$\frac{{R}_{i}}{{A}_{i}} = {∝}_{i} \cdot \frac{i}{( N + 1 - i )} \cdot \frac{{R}_{N + 1 - i}}{{A}_{N + 1 - i}} \qquad ( A )$$
and with the resistance-to-area ratio (R/A) of each of said (j) output header segments given by Equation B:
$$\frac{{R}_{j}}{{A}_{j}} = {∝}_{j} \cdot \frac{( N + 1 - j )}{j} \cdot \frac{{R}_{N + 1 - j}}{{A}_{N + 1 - j}} \qquad ( B )$$
and the R/A of each of said segments given by Equation C:
$$\frac{R}{A} = \frac{μ \cdot L \cdot Re \cdot f \cdot {( W + H )}^{2}}{2 \cdot {W}^{3} \cdot {H}^{3}} + \frac{μ \cdot {A}_{T} \cdot Re \cdot f \cdot ( W + H )}{4 \cdot {W}^{3} \cdot {H}^{3}} \qquad ( C )$$
where μ is the fluid's viscosity, Re is the Reynolds number, and f is the friction factor;
and with W and/or H in at least 70 percent of said segments configured to satisfy Equation A and Equation B with ∝ within 0.2 to 2 and give a flow non-uniformity index F₁ of less than 0.3 according to Equation D:
$${F}_{1} = \frac{max ( {v}_{1} \text{:} {v}_{N} ) - min ( {v}_{1} \text{:} {v}_{N} )}{max ( {v}_{1} \text{:} {v}_{N} )} \qquad ( D )$$
and/or a relative standard deviation of v₁:v_{N} less than 25 percent, where vᵢ is the fluid's average velocity in the i^{th} parallel channel.

13. The fuel cell of claim 12, wherein said fuel channels and said oxygen channels are arranged in counter-flow, cross-flow, or co-flow configuration.

14. The fuel cell of claim 12, comprising 10 to 2,000 membrane electrode assembly (MEA) layers.

15. The fuel cell of claim 12, wherein said semipermeable membrane comprises an anode layer facing said fuel channels, a cathode layer facing said oxygen channels, and an electrolyte layer separating said anode layer and said cathode layer.

16. The fuel cell of claim 12, wherein said fuel cell is a planar solid-oxide fuel cell (SOFC).

17. A method of circulating fuel and/or oxygen through fuel and/or oxygen channel arrays in a fuel cell in an energy-generating effective amount, wherein a fuel cell of claim 12 is used as said fuel cell in which said fuel and/or oxygen is circulated.
